(19) United States
(12) Patent Application Publication
(10) Pub. No.: US 2002/0099944 A1
(43) Pub. Date: Jul. 25, 2002

(54) Method and apparatus which enable a computer user to prevent unauthorized access to files stored on a computer

(76) Inventor: Bradley Allen Bowlin, Fort Collins, CO (US)

Correspondence Address: HEWLETT-PACKARD COMPANY, Inetllcutal Property Administration, P.O. Box 272400, Fort Collins, CO, 80527-2400, US

(21) Appl. No.: 09/766,065

(22) Filed: Jan. 19, 2001

(51) Int. Cl. H04L 9/00

(52) U.S. Cl. 713/185

(57) ABSTRACT

A method which enables a user to prevent unauthorized access to files stored on a computer may include several steps. One step involves maintaining a first database which identifies files stored on the computer to be included in a safe zone. Another step involves maintaining a second database which defines authorized accesses to the files within the safe zone. Yet another step involves providing the computer with a filter. Upon a request for access to a file stored on the computer, the filter accesses the first database and determines whether the file is within the safe zone. If the file is determined to be within the safe zone, the second database is accessed to determine whether the request to access the file has been authorized. If the request is determined to be unauthorized, access to the file is denied. If the request is determined to be authorized, access to the file is granted.

### FIELD OF INVENTION

This invention relates generally to methods and apparatus which enable a computer user to prevent unauthorized access to files stored on a computer. More specifically, the invention relates to methods and apparatus which enable a computer user to select files stored on the computer to be included in a safe zone and to select or authorize system activities (e.g., applications, processes, services, agents, users, etc.) that will be allowed to access the files within the safe zone, and thereby prevent unauthorized system activities from accessing any of the files within the safe zone.

### BACKGROUND

Each day, more and more people are accessing the Internet and/or connecting to various networks. Once connected to the Internet, a computer user is said to be online, with his or her computer becoming part of the global network of computers that is the Internet. If allowed, an online computer can transmit and receive information from any one of the millions of Internet-connected computers.

People use the Internet for a variety of purposes. By using special software programs (e.g., Web browsers and E-mail), a user can read the latest news, use financial services for selling and buying stocks, download software and music, listen to live broadcast events, and send or receive E-mail. Indeed, the variety of things people can do online is far too numerous to fully list herein, especially when considering that new Internet uses are being discovered continuously.

While connected to the Internet, a computer user will often download applications, applets, plug-ins, etc. from the Internet and run these items on his or her computer. Most computer systems prohibit, or at least attempt to prohibit, remote applications from operating outside of the computer's “sandbox.” In other words, a remote application is supposed to operate within a constrained arena (the sandbox) so that the remote application is prevented from accessing the entirety of the computer's local hard disk or the network to which that computer belongs. Although such operational constraints may restrict the capabilities of remote applications, these constraints are designed to provide some measure of protection and help prevent remote applications from gaining unauthorized access to information stored on the computer.

Often, however, remote applications violate the sandbox boundaries and operate outside the constrained area in which they are supposed to operate. Once this happens, the remote application may be able to obtain unauthorized access to information stored on the computer (e.g., information stored on the computer's local hard drive, and other information on the network to which the computer belongs).

Although today's operating systems allow some files to be designated as shared files (those files that the user has selected to share with remote computers), they do not prevent applications running on the computer's local box, but outside the sandbox, from accessing files stored on the computer (even when the applications are instigated by remote computers/processes). In other words, operating systems are better at allowing access than prohibiting access.

Similarly to the file access hazards posed by the Internet, a computer user is faced with a host of additional file access hazards. For example, a user whose computer is connected to a LAN (local area network), WAN (wide area network), peer-to-peer or other form of network is also subject to having files on his or her computer accessed without notice. Although an operating system such as Microsoft's Windows 98 may allow a user to denote certain files as “shared”, and the user may assume that other files will not be shared, adequate protections for ensuring that sensitive files will not be accessed do not exist. In fact, even though non-shared files may not be readily accessible through a file navigation tool such as Windows Explorer, applications can often obtain relatively easy access to non-shared files. Another problem is that the distinction between shared and non-shared files is one which exists primarily for file accesses initiated entirely from a remote process. Sometimes, however, an application or other piece of program code may be installed on a user's own computer, and may access files locally, but then transmit file contents to a remote process. These local file accesses can also present problems for a user—especially when the locally installed program code is a Trojan process forming part of a virus, etc.

Accordingly, a need remains for a system that enables a computer user to prevent unauthorized access to files stored on his or her computer.

### SUMMARY OF THE INVENTION

To in part fulfill the aforementioned need, the inventor has devised methods which enable a user to prevent unauthorized access to files stored on a computer. One embodiment of the invention may include several steps. One of those steps involves maintaining a first database which identifies files stored on the computer to be included in a safe zone. Another step involves maintaining a second database which defines authorized accesses to the files within the safe zone. Yet another step involves providing the computer with a filter. Upon a request for access to a file stored on the computer, the filter accesses the first database and determines whether the file is within the safe zone. If the file is determined to be within the safe zone, the second database is accessed to determine whether the request to access the file has been authorized. If the request is determined to be unauthorized, access to the file may be denied. If the request is determined to be authorized, access to the file may be granted.

Also disclosed is apparatus which according to one embodiment of the invention comprises a computer readable storage media and computer readable program code stored thereon. The computer readable program code comprises program code for maintaining a first database which identifies files stored on the computer to be included in a safe zone; program code for maintaining a second database which defines authorized accesses to the files within the safe zone; and program code for providing the computer with a filter. The computer readable program code also includes program code for utilizing the filter to access the first database and determine whether a file for which access has been requested is within the safe zone; and program code for accessing the second database to determine whether the request to access the file has been authorized if the file is determined to be within the safe zone. The computer readable program code may further comprise program code for denying access to the file if the request is determined to be unauthorized.

### BRIEF DESCRIPTION OF THE DRAWING

Illustrative and presently preferred embodiments of the invention are shown in the accompanying drawing in which:

FIG. 1 illustrates a computer system in which the present invention may be used;

FIG. 2 is a flowchart representation of a method which enables a computer user to prevent unauthorized access to files stored on a computer;

FIG. 3 is a block diagram representation of the components of apparatus which enables a computer user to prevent unauthorized access to files stored on a computer;

FIG. 4 illustrates a screen display which might be presented to a computer user using the method illustrated in FIG. 2 or the apparatus illustrated in FIG. 3;

FIG. 5 illustrates a second screen display which might be presented to a computer user using the method illustrated in FIG. 2 or the apparatus illustrated in FIG. 3;

FIG. 6 illustrates a third screen display which might be presented to a computer user using the method illustrated in FIG. 2 or the apparatus illustrated in FIG. 3;

FIG. 7 illustrates the steps involved for an application to access a file stored on a computer;

FIG. 8 illustrates the steps involved for an application to access a file stored on a computer that is provided with a filter according to one embodiment of the present invention;

FIG. 9 illustrates a first embodiment of an authorization database;

FIG. 10 illustrates a second embodiment of an authorization database;

FIG. 11 illustrates a third embodiment of an authorization database;

FIG. 12 illustrates a fourth embodiment of an authorization database; and

FIG. 13 illustrates a fourth screen display which might be presented to a computer user using the method illustrated in FIG. 2 or the apparatus illustrated in FIG. 3.

### DETAILED DESCRIPTION OF THE INVENTION

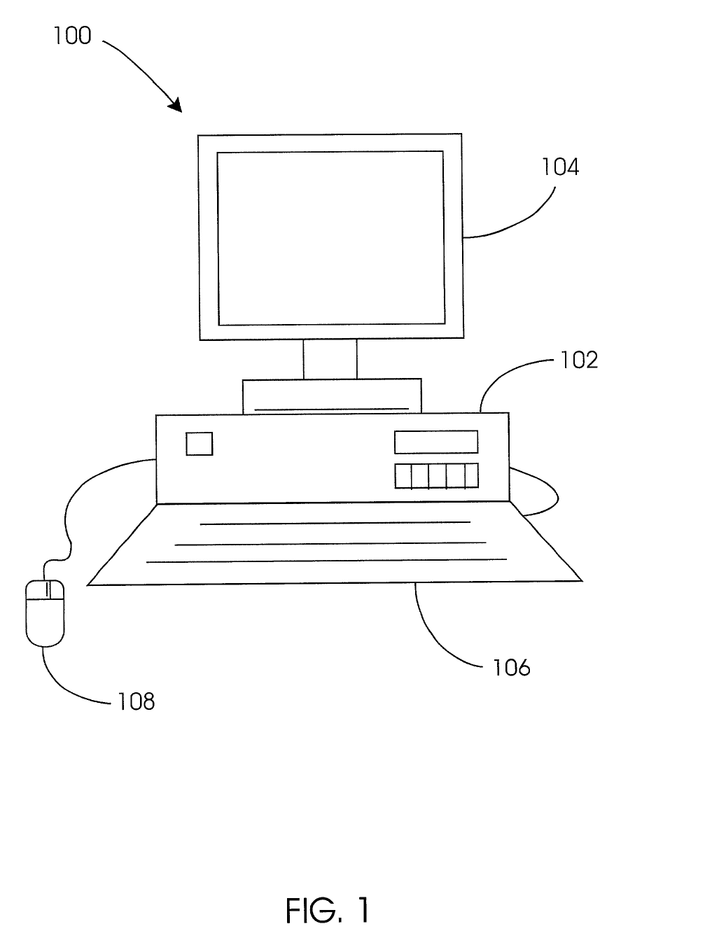

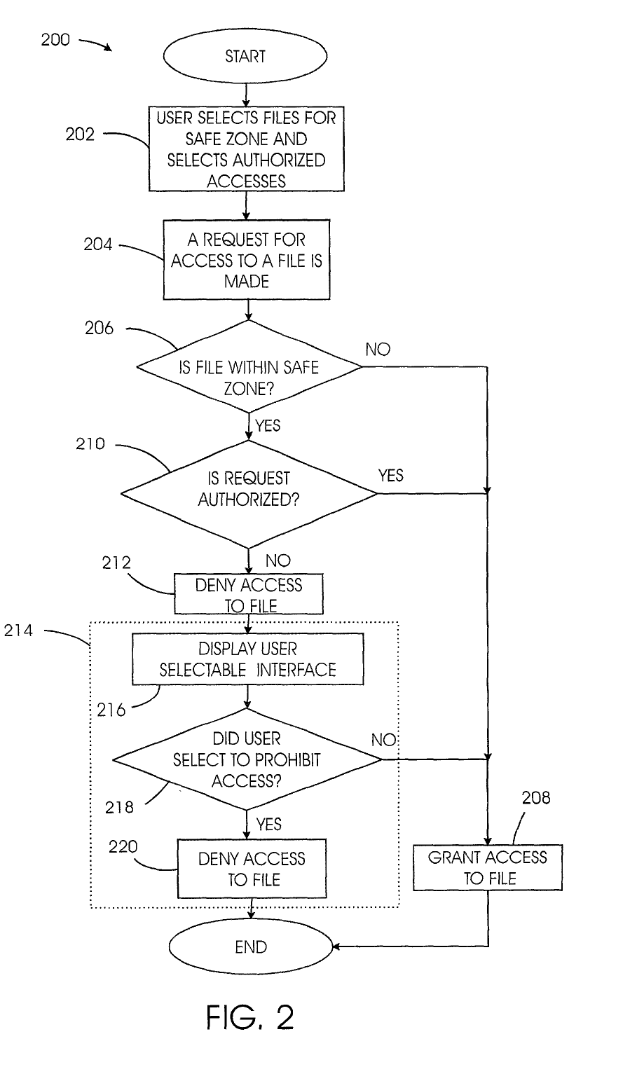

A method 200 according to one embodiment of the present invention is shown in FIG. 2 and is described herein as it could be used in a computer system 100 to prevent unauthorized access to files stored on the computer system 100. An exemplary computer system 100 in which the method 200 may be used is shown in FIG. 1 and may comprise a processing unit 102, a monitor 104, a keyboard 106, and a mouse 108. Alternatively, and as will be described in greater detail below, the method 200 may be used in a wide range of other systems or devices with data storage capabilities. Accordingly, the present invention should not be regarded as limited to use in conjunction with the computer system 100 shown and described herein.

As shown in FIG. 2, the method 200 generally comprises the following steps. In the first step 202 of method 200, the user selects what files (e.g., file 420) stored on the computer system 100 will be included in a safe zone and selects authorized accesses (e.g., application accesses, process accesses, service accesses, system agent and user accesses, etc.) to the files within the safe zone. Assuming that a request to access a file is made (step 204), a filter 306 determines at step 206 whether the file to be accessed is within the safe zone. If the requested file is determined to be not within the safe zone, access to the file is granted in step 208. However, if the file is determined to be within the safe zone, a determination is made at step 210 as to whether the request is authorized. If the request is determined to be authorized, access to the file is granted at step 208. But if the request is determined to be unauthorized, access to the file is denied (step 212).

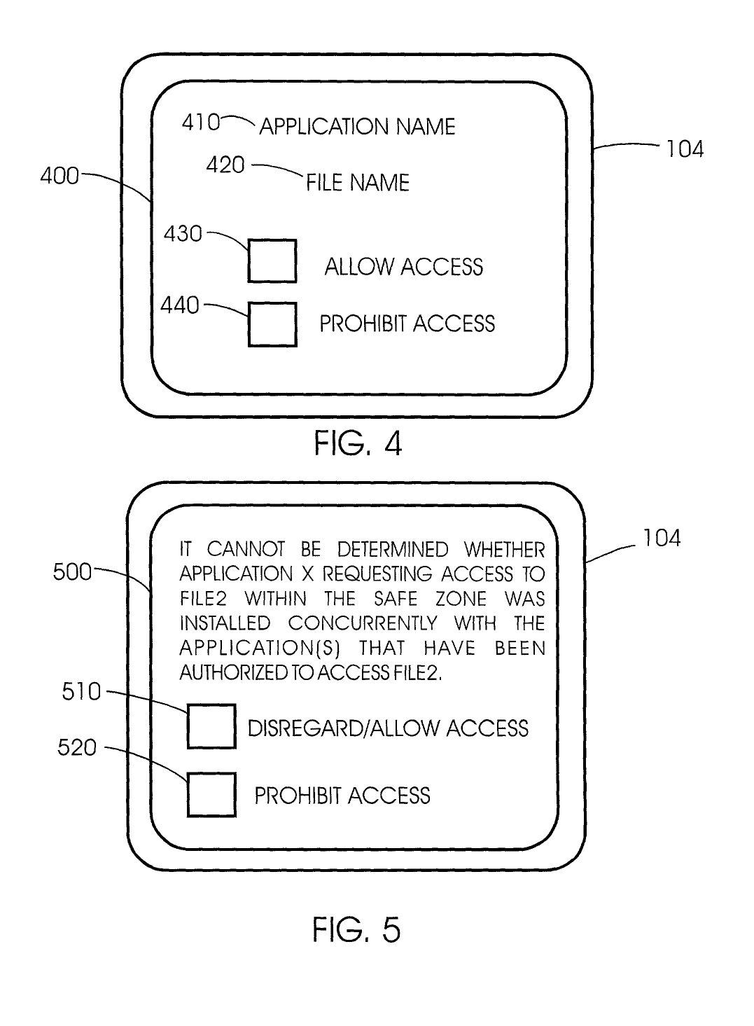

It is generally preferred, but not required, that the method 200 comprise additional steps 214 (shown in broken lines in FIG. 2) that allow the user to confirm or reverse the decision to deny access to the requested file. Assuming that an application 410 has been denied access to a file 420 at step 212, a user selectable interface 400 (e.g., icon or dialog box) may be displayed on the computer display screen 104 at step 216 that prompts the user to either confirm or reverse the decision to deny access to the file 420. As shown in FIG. 4, the user selectable interface 400 may first indicate to the user the identities of the application 410 requesting access and the file 420 being requested and may then allow the user to select between either allowing access 430 or prohibiting access 440. In step 218, a determination is made as to whether the user selected to prohibit access to the file 420. If it is determined that the user selected to prohibit access, the application 410 is denied access to the file 420 at step 220. However, if it is determined that the user chose to allow access, the application 410 is granted access to the file 420 at step 208.

A significant advantage of the present invention is that it allows a computer user to prevent unauthorized access to files stored on a computer. More specifically, it allows the user to select files stored on a computer to be included in a safe zone and to select authorized accesses (e.g., application accesses, process accesses, service accesses, system agent and user accesses, etc.) to the files within the safe zone. In other words, unauthorized accesses, including applications operating on the local box of the computer, can be prevented from accessing the files within the safe zone unless the user decides otherwise.

Another significant advantage of the present invention is that the user can be notified when an unauthorized request to access a file within the safe zone has been made. The user may also be provided with the identities of the unauthorized application, user, agent, process, system activity, service, etc. making the request and the file being requested.

Yet another advantage of the present invention is that the user is able to override the safe zone protection. In other words, if access to a file within the safe zone has been denied, the user may be prompted to either confirm or reverse the decision to deny access. By properly responding when prompted to do so, the user can reverse the decision to deny access and allow access to a safe zone file even though initially, the request to access the file was determined to be unauthorized.

Having briefly described the method 200 according to one embodiment of the present invention, as well as some of its more significant features and advantages, the various preferred embodiments of the present invention will now be described in detail. However, before proceeding with the description, it should be noted that although the method 200 is shown and described herein as it could be used in the computer system 100, it could also be used in any of a wide range of other devices or systems with data storage capabilities, including but not limited to: mainframe computers, workstations, personal computers, secure phones, secure faxes, automated teller machines (ATMS), calculators, hand-held organizers, pagers, and cell phones. Accordingly, the present invention should not be regarded as limited to use in conjunction with the computer system 100 shown and described herein.

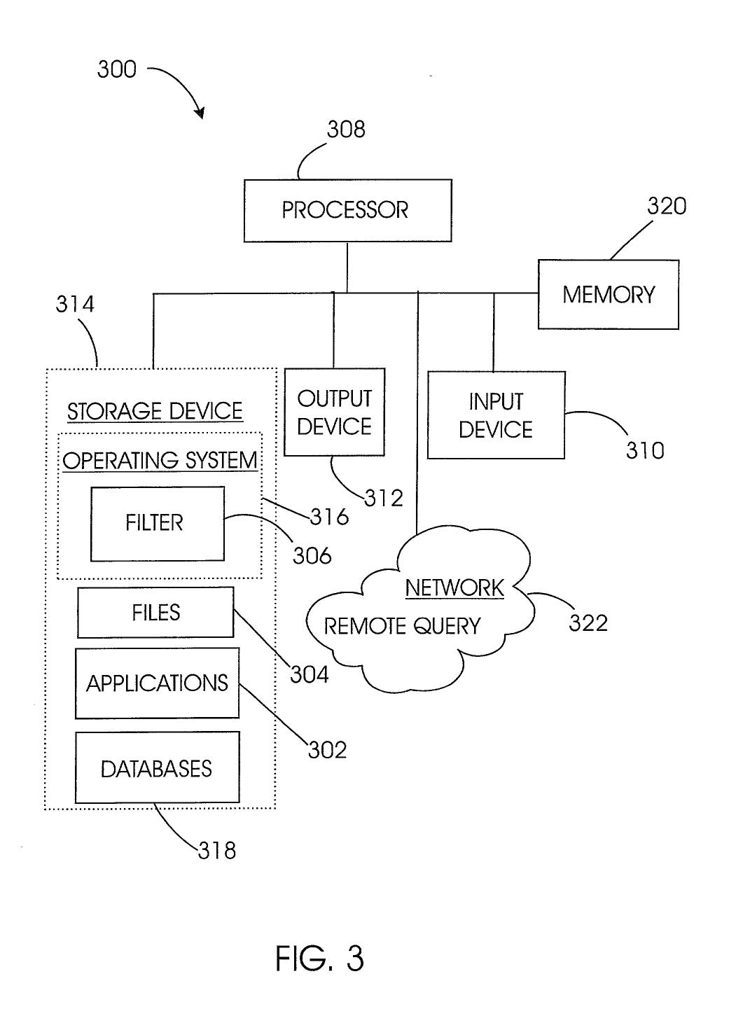

FIG. 3 shows various of the hardware and software components 300 which enable a computer user to prevent unauthorized access to files stored on the computer system 100. The apparatus 300 may comprise a processor or central processing unit (CPU) 308, an input device 310 (e.g., keyboard 106, mouse 108) and an output device 312 (e.g., monitor 104). The apparatus 300 may further include a storage device 314 having an operating system 316, filter 306, files 304, applications 302, and databases 318 stored therein. The operating system 316, once installed, may manage the various tasks, jobs, data and devices of the computer system 100. The apparatus 300 may further include a memory 320 which the operating system 316 may access in carrying out its functions. Contained within a computer readable stored device such as storage device 314 or memory 320 may be computer readable program code for performing or carrying out the various steps of method 200, which steps were discussed briefly above and are discussed in much greater detail below. The CPU 308 may be linked over a network 322 (e.g., a Wide Area Network (WAN), a Local Area Network (LAN), an Intranet, or the Internet) to a server or pool of servers (not shown).

It is understood that the CPU 308 may comprise any of a wide range of suitable processors, as would be obvious to persons having ordinary skill in the art after having become familiar with the teachings of the present invention. For example, the CPU 308 may comprise an Intel PENTIUM® processor, an entire laptop or desktop personal computer (PC), a Palm Pilot®, or an application specific integrated circuit (ASIC) specifically manufactured for use with the present invention. Likewise, the storage device 314 and memory 320 can be any suitable computer readable storage mediums, such as read only memory (ROM), random access memory (RAM), video memory (VRAM), hard disk, floppy diskette, compact disc (CD), magnetic tape, a combination thereof, etc. Further, the CPU 308 and memory 320 need not be separate units and can be combined, or alternatively, the CPU 308 and memory 320 can be separately housed and linked to one another over a remote network or other suitable connection. In addition, there can be any number of CPUs 308 (i.e., one or more), any number of storage devices 314 (i.e., one or more) and/or any number of memories 320 (i.e., one or more) that are connected or linked via the Internet, Intranet, LAN, WAN, etc. In such a scenario, the storage of the computer readable program code may be distributed over the various storage devices 314 and memories 320 and/or executed in parts by the various CPUs 308. Moreover, any number of suitable peripheral devices (e.g., monitor 104, keyboard 106, mouse 108, printer, scanner, disk, tape, graphics tablet, touch pad, joy stick, paddle, etc.) may be connected to the CPU 308 either directly or indirectly (e.g., over the network 322). The CPU 308 can be linked to the network 322 using any suitable connection (e.g., modem, T-1, digital subscriber line (DSL), infrared, etc.). Furthermore, although the files 304 are shown to be stored within the storage device 314, the files 304 may be stored within the memory 320. Alternatively, other file storage methods and locations are possible. Finally, although the applications 302 are shown in FIG. 3 to be operating within the storage device 314, such need not be the case. For example, the applications 302 could be operating within remote computers connected to the processor 308 via network 322.

Within or forming a part of the operating system 316 may be the filter 306. See FIGS. 3 and 8. The filter 306 may comprise computer readable program code stored on a computer readable storage media. The program code allows the filter 306 to make a determination as to whether a requested file (e.g., file 420) is within the safe zone (step 206). It is generally preferred, but not required, that the filter 306 be configured or designed such that it is only activated by remote queries to the computer system 100.

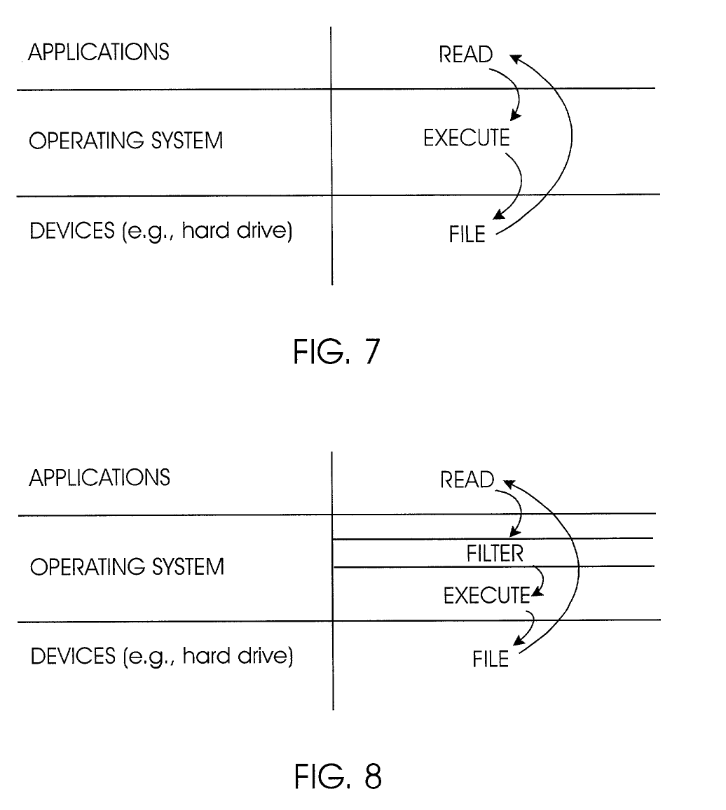

FIG. 7 shows the typical manner in which an application obtains access to a file. First, the application makes a request to the operating system for access to the file since the operating system, and not the application, knows where the files are actually stored and how to obtain them. The operating system may then execute the request by finding and delivering the requested file to the application. If the operating system is provided with a filter according to the present invention (FIG. 8), however, the operating system may not deliver the file until after the filter determines that the requested file is not within the safe zone, or if it is, not until after a determination has been made that the request is authorized.

As discussed briefly above, FIG. 2 shows the various steps comprising the method 200 that may be used in conjunction with the computer system 100. It is to be understood, however, that the steps shown in FIG. 2 need not be performed in the particular order shown therein. It is also to be understood that the present invention contemplates methods including fewer steps and methods including additional steps than what are shown in FIG. 2. In other words, the arrangement shown in FIG. 2, as are the arrangements shown in FIGS. 1 and 3-12, is merely illustrative and not intended to limit the teachings of the present invention.

In the first step 202, computer readable program code allows the computer user to select what files stored on the computer system 100 will be included in the safe zone. Alternatively, the program code could require the user to select entire directories rather than specific files. The program code could also provide the user with the option of selecting entire directories and/or specific files.

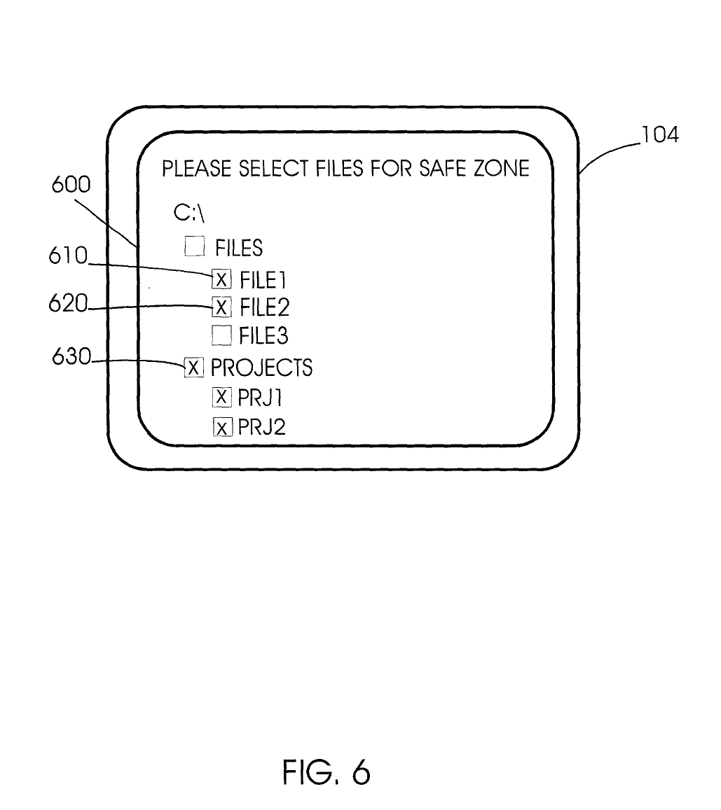

To make the selections for the safe zone, the user may be presented with a display screen 600 such as the one illustrated in FIG. 6. The display screen 600 may, for example, mimic an operating system's own method of displaying files and directories to a user (e.g., Microsoft®'s Windows Explorer). The user may be able to select files and/or entire directories for the safe zone by simply marking the check boxes (e.g., 610, 620 and 630) which are associated with files and directories presented on the computer display screen 104. The check boxes may be marked using an appropriate input device 310 associated with the computer system 100 (e.g., mouse 108, keyboard 106, pen tablet, touch screen, or trackball). For example, FIG. 6 shows that the user has selected for the safe zone two individual files (FILE1 and FILE2) and an entire directory (PROJECTS) by marking the check boxes 610, 620 and 630. Alternatively, other methods of selecting the files and/or directories to be included in the safe zone are possible. For example, the selections could be made by the user uttering voiced responses.

It is also envisioned that a user may not be prompted to select safe zone files, but that such a determination may be made in advance for a user. For example, a system administrator might provide a user with a disk which instructs the user's computer as to which of its files should be included within a safe zone. Alternatively, an operating system might create and manage a real or virtual directory, the sole purpose of which is to serve as a safe zone. Thus, a user might select safe zone files by transferring or copying the files into the operating system's safe zone directory.

As mentioned above, the present invention also contemplates methods including more steps than what are shown in FIG. 2. For example, the method 200 may further comprise maintaining a first database which identifies the files the user has selected for the safe zone. The filter 306 may access the first database in step 206 to verify whether a file for which access has been requested is within the safe zone. The first database may be created and updated by the computer code stored in the storage device 314, memory 320, the filter 306, and/or a combination thereof.

The first database may be a distributed database which comprises a file (e.g., a hidden file) within each directory containing one or more of the files which were identified by the first database to be included in the safe zone. The filter 306 may access the files of the distributed database in step 206 to verify whether a file for which access has been requested is within the safe zone. The files may be created and updated by the computer code stored in the storage device 314, memory 320, the filter 306, and/or a combination thereof.

It is generally preferred, but not required, that the first database and the files of the distributed database be encrypted. Any of a wide range of encryption algorithms that are well-known in the art could be used to encrypt the first database and the files of the distributed database. However, since encryption algorithms are well-known in the art and could be easily provided by persons having ordinary skill in the art after having become familiar with the teachings of the present invention, the encryption algorithm utilized in one preferred embodiment of the invention will not be described in detail herein.

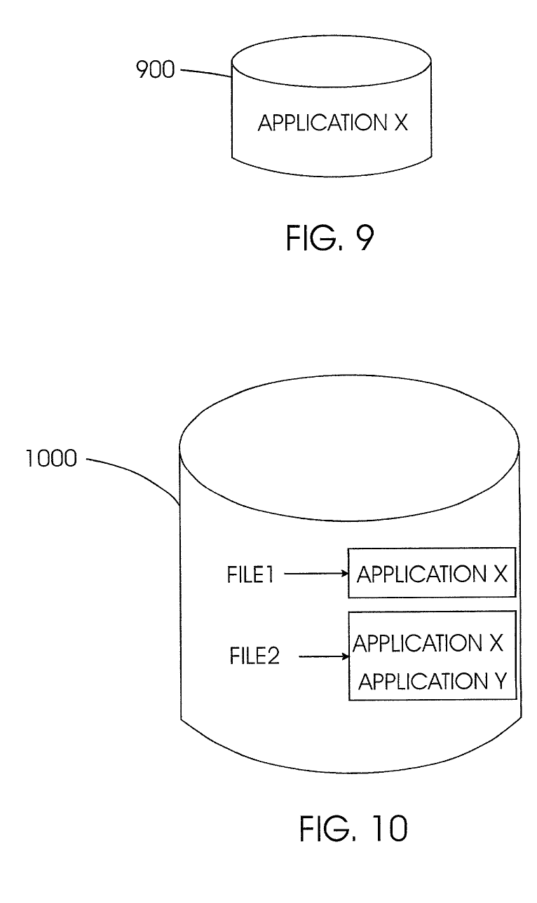

Still referring to the first step 202, computer readable program code may allow the user to select the authorized accesses (e.g., application accesses, process accesses, user accesses, etc.) to the files within the safe zone. A second or authorization database 900 may be maintained which defines the authorized accesses to the files within the safe zone. See FIG. 9. Although the database 900 shown in FIG. 9 only contains a single authorized application (APPLICATION X) which is authorized to access all safe zone files, it could also contain processes, services, agents, users, other applications, and/or a combination thereof, all of which are provided access to all safe zone files.

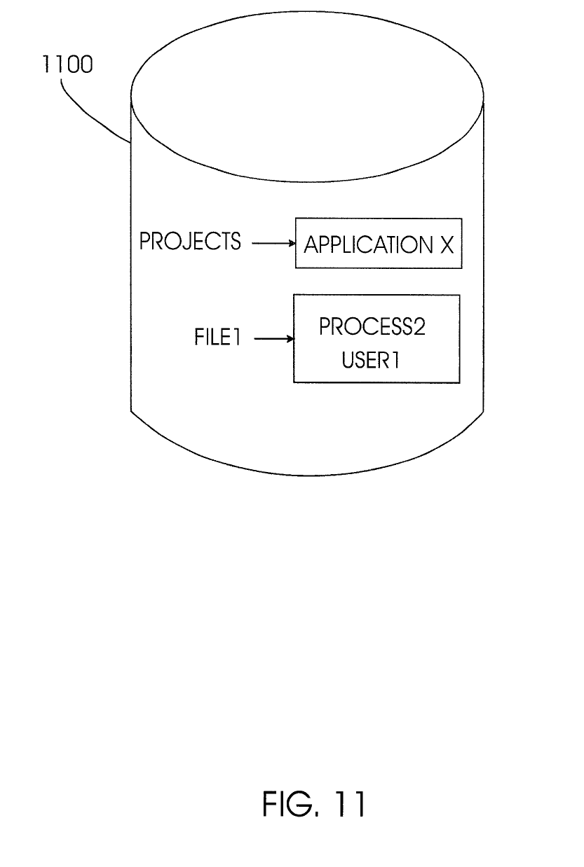

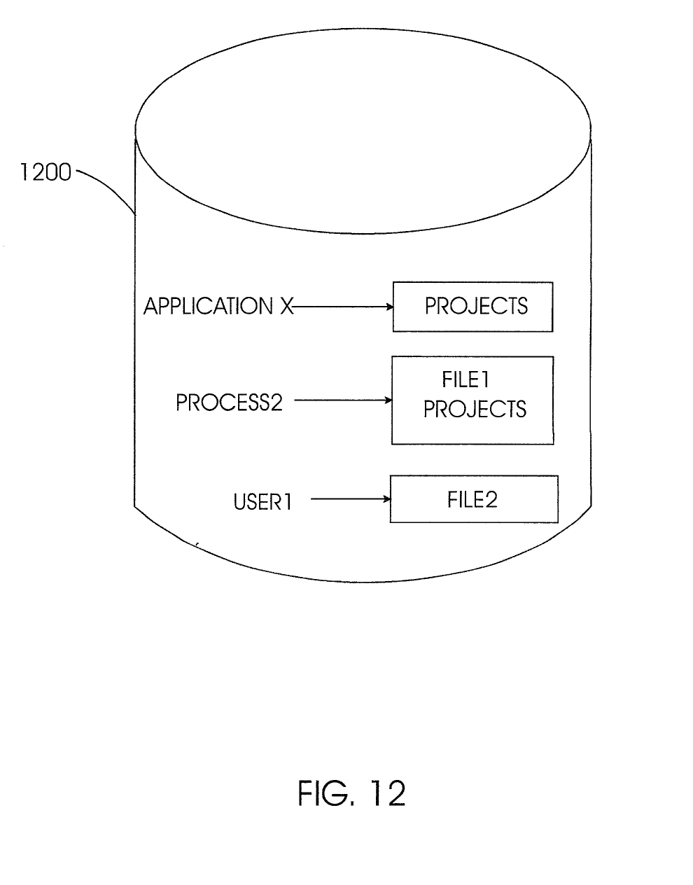

It is generally preferred, but not required, to have program code for allowing the user to designate which files or directories within the safe zone each authorized application, process, user, etc. is allowed to access. In such an arrangement, each authorized application would not be able to access the entire safe zone but would rather have limited access to only those files or directories within the safe zone that the user has earmarked or designated for that respective application, process or user. Thus, step 202 might present the user with a prompt which allows the user to designate or earmark specific files and/or entire directories which correspond to each authorized access. If so, a database 1000 may be maintained which defines the authorized accesses for each respective file or directory within the safe zone. See FIG. 10. For example, FIG. 10 shows that the user has authorized APPLICATION X and APPLICATION Y to access FILE2 but has only provided authority for APPLICATION X to access FILE1. Another example can be seen in FIG. 11, in which the user has authorized APPLICATION X to access the entire PROJECTS directory and has authorized PROCESS2 and USER1 to access FILE1. In the previous two examples, the databases 1000 and 1100 both indicate the authorized accesses for each respective file or directory within the safe zone. Alternatively, a database 1200 may be maintained that indicates for each authorized application, process, user, etc. the files and/or directories for which authorization has been given. For example, FIG. 12 shows that the user has authorized APPLICATION X to access the PROJECTS directory, has authorized PROCESS2 to access FILE1 and the PROJECTS directory, and has authorized USER1 to access FILE2.

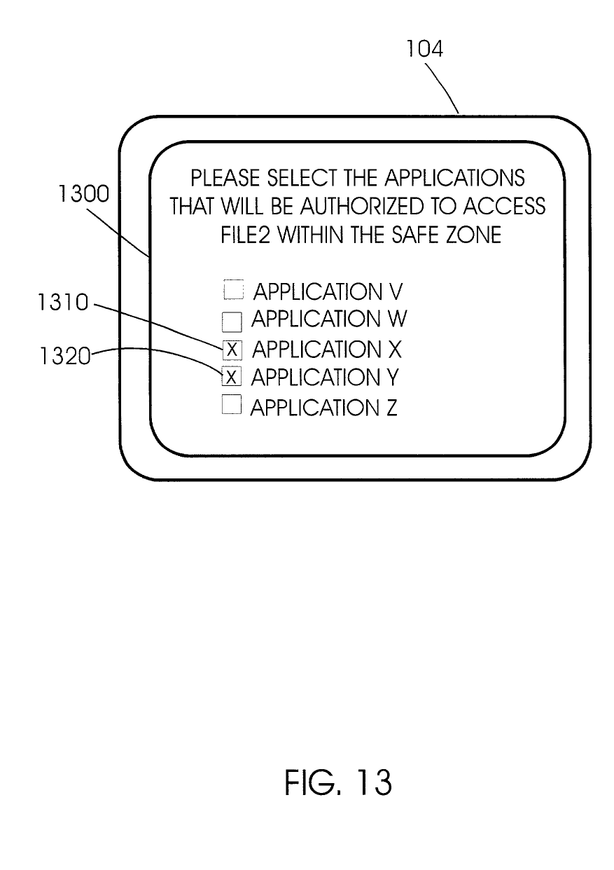

Regardless of the type of authorization database, it is generally preferred, but not required, that an interface be provided through which the user can update the database defining the authorized accesses. This interface may comprise, for example, the screens illustrated in FIG. 4 or 5, which might provide for updating an authorization database in the midst of a file access request. Alternatively, or additionally, the interface may comprise a screen 1300 such as that illustrated in FIG. 13. In FIG. 13, a user is presented a list of applications which are registered with an operating system, and for each safe zone file or directory is able to grant or deny applications access by selecting authorized applications from the list of registered applications. The user may be able to select the authorized applications by simply marking the check boxes (e.g., 1310 and 1320) which are associated with applications presented on the computer display screen 104. The check boxes may be marked using an appropriate input device 310 associated with the computer system 100 (e.g., mouse 108, keyboard 106, pen tablet, touch screen, or trackball). For example, FIG. 13 shows that the user has authorized APPLICATION X and APPLICATION Y to access FILE2. Alternatively, other methods of selecting the authorized accesses to the safe zone files and directories are possible. For example, the selections could be made by the user uttering voiced responses.

It is also preferable to have the database defining the authorized accesses encrypted. Any of a wide range of encryption algorithms that are well-known in the art could be used to encrypt the database defining the authorized accesses. However, since encryption algorithms are well-known in the art and could be easily provided by persons having ordinary skill in the art after having become familiar with the teachings of the present invention, the encryption algorithm utilized in one preferred embodiment of the invention will not be described in detail herein.

Referring now back to FIG. 2, upon a request for access to a file stored on the computer system 100 (step 204), the filter 306 determines whether the file to be accessed is within the safe zone (step 206). If it is determined that the requested file is not within the safe zone, access is granted in step 208. However, if it is determined that the requested file is within the safe zone, a determination is then made in step 210 as to whether the request is authorized. If the request is determined to be authorized, access to the file is granted in step 208. But if the request is determined to be unauthorized, access to the file is denied in step 212.

Although it is not required, the method 200 may comprise the additional steps 214 (shown in broken lines in FIG. 2) that allow the user to confirm or reverse the decision to deny access to the requested file. Assuming that an application 410 has been denied access to a file 420 at step 212, a user selectable interface 400 (e.g., icon or dialog box) may be displayed on the monitor 104 (step 216) that prompts the user to either confirm or reverse the decision to deny access to the file 420. As shown in FIG. 4, the user selectable interface 400 may indicate to the user the identity of the application 410 making the request and the identity of the file 420 being requested. The user selectable interface 400 may allow the user to select between allowing access and prohibiting access by simply marking the check box 430 or 440 on monitor 104. The check boxes 430 and 440 may be marked using an appropriate input device 310 associated with the computer system 100 (e.g., mouse 108, keyboard 106, pen tablet, touch screen, or trackball). Alternatively, other methods of identifying the application 410 and file 420, of prompting the user, and of responding to the prompt are possible. For example, the prompt and the identities of the application 410 and file 420 may be audibly presented to the user and the user may be allowed to respond to the prompt by uttering a voiced response.

In optional step 218, a determination is made as to whether the user selected to prohibit access to the file 420. If it is determined that the user chose to prohibit access, the application 410 is denied access to the file 420 at step 220. However, if it is determined that the user chose to allow access, the application 410 is granted access to the file 420 at step 208.

Program code may also be provided for preventing the application 410 from accessing the file 420 if the user does not respond to the prompt 400 within a predetermined amount of time (e.g., 10 seconds).

The method 200 may further comprise steps which assist the user in identifying Trojan processes. A Trojan process is, for example, a process that appears to be associated with Application X when it is in fact associated with Application Y. After it has been determined that the requested file is within the safe zone and that the request for access was authorized, it is possible that the authorized request was actually initiated by a Trojan process. To help identify and thus prevent Trojan processes from gaining unauthorized access to files stored on the computer, the method 200 may further comprise determining what application the request appears to be associated with and also determining whether a timestamp which is associated with the request is consistent with one or more timestamps associated with the application's install. The method 200 may also include determining whether a directory from which the request for access was launched is an appropriate storage location for the process making the request. If it is determined that the timestamps are inconsistent and/or that the directory is an inappropriate storage location for the process from which the request was launched, then there is a possibility that the file request was made by a Trojan process and access should be denied. Alternatively, the user may be presented with a warning prompt 500 that warns the user about the possibility of a Trojan process and prompts the user to either disregard the warning and allow access 510 or prohibit access 520.

In the embodiment shown and described herein, the user may be presented the warning prompt 500 shown in FIG. 5 if it cannot be determined that the application requesting access to a file within the safe zone was installed concurrently with the authorized application it has been either identified as or associated with. The warning prompt 500 may be presented to the user in various ways such as displaying the warning prompt 500 on the computer monitor 104 (FIG. 5) or by audibly presenting the warning prompt 500 to the user. Program code may be provided that allows the user to respond to the warning prompt 500 in a variety of ways. For example, the user may be able to either disregard the warning and allow access or prohibit access by simply marking a check box 510 or 520 on the computer display screen 104 with a single mouse click, a single keystroke or other input device. Alternatively, the user may be required to respond to the warning prompt 500 by uttering a voiced response. Other methods of presenting the warning prompt 500 and for allowing the user to respond thereto are possible, as would be obvious to persons having ordinary skill in the art after having become familiar with the teachings of the present invention.

Regardless of the manner in which the warning prompt 500 is presented and the manner in which the user is required to respond thereto, if the user's response to the warning prompt 500 indicates that the user chooses to prohibit access, program code prevents the application making the request from accessing the requested file. Program code may also be provided for preventing the application from accessing the file if the user does not respond to the warning prompt 500 within a predetermined amount of time (e.g., 10 seconds).

It is to be understood that the computer readable program code can be conventionally programmed using any of a wide range of suitable computer readable programming languages that are now known in the art or that may be developed in the future. It is also to be understood that the computer readable program code can include one or more functions, routines, subfunctions, and subroutines, and need not be combined in a single software package.

Although it is envisioned that the invention disclosed herein will be implemented in software or firmware code, it is believed that a disclosure of such code is not necessary, as one skilled in the programming arts should be able to generate such code without undue experimentation given the disclosure of the invention found in this description. Accordingly, the details associated with the programming of the computer system or the details of the computer readable program code itself will not be discussed in further detail herein.

It is contemplated that the inventive concepts herein described may be variously otherwise embodied and it is intended that the appended claims be construed to include alternative embodiments of the invention except insofar as limited by the prior art.

What is claimed is:

1. A method which enables a user to prevent unauthorized access to files stored on a computer, comprising:
maintaining a first database which identifies files stored on the computer to be included in a safe zone;
maintaining a second database which defines authorized accesses to said files within said safe zone;
providing said computer with a filter;
upon a request for access to a file stored on said computer, utilizing said filter to access said first database and determine whether said file is within said safe zone; and
if said file is determined to be within said safe zone, accessing said second database to determine whether said request to access said file has been authorized.

2. A method as in claim 1, further comprising, if said request is determined to be unauthorized, then denying access to said file, else granting access to said file.

3. A method as in claim 2, further comprising, if access to said file is denied, then subsequently prompting said user to confirm or reverse said decision to deny access.

4. A method as in claim 3, wherein prompting said user to confirm or reverse said decision to deny access comprises indicating to said user an identity of an application that has requested access to said file.

5. A method as in claim 1, further comprising providing an interface through which said user can update said first database.

6. A method as in claim 1, further comprising providing an interface through which said user can update said second database.

7. A method as in claim 1, further comprising encrypting said first database.

8. A method as in claim 1, further comprising encrypting said second database.

9. A method as in claim 1, wherein:
said first database is a distributed database, said distributed database comprising a file within each directory containing one or more of said files which were identified by said first database to be included within said safe zone; and
said filter accessing said first database comprises said filter accessing the files of said distributed database to verify whether said file for which access has been requested is within said safe zone.

10. A method as in claim 9, further comprising encrypting the files of said distributed database.

11. A method as in claim 1, further comprising, if said request for access is determined to have been made to a file within said safe zone, and if said request is determined to be authorized, then attempting to determine whether said request was initiated by a Trojan process.

12. A method as in claim 11, wherein attempting to determine whether said request was initiated by a Trojan process comprises determining what application the request appears to be associated with, and also determining whether a timestamp which is associated with the request is consistent with one or more timestamps associated with the application's install.

13. A method as in claim 11, wherein attempting to determine whether said request was initiated by a Trojan process comprises determining whether a directory from which said request was launched is an appropriate location for the process making said request to be stored.

14. A method as in claim 1, wherein said filter is a part of an operating system which is installed on said computer.

15. A method as in claim 1, wherein said filter is only activated by remote queries to said computer.

16. Apparatus which enables a user to prevent unauthorized access to files stored on a computer, comprising:
at least one computer readable storage media; and
computer readable program code stored on said at least one computer readable storage media, said computer readable program code comprising:
program code for maintaining a first database which identifies files stored on said computer to be included in a safe zone;
program code for maintaining a second database which defines authorized accesses to said files within said safe zone;
program code for providing said computer with a filter;
program code for utilizing said filter to access said first database and determine whether a file for which access has been requested is within said safe zone; and
program code for accessing said second database to determine whether said request to access said file has been authorized if said file is determined to be within said safe zone.

17. The apparatus of claim 16, further comprising program code for denying access to said file if said request is determined to be unauthorized, else for granting access to said file.

18. The apparatus of claim 17, further comprising program code for prompting said user, if access to said file denied, to confirm or reverse said decision to deny access.

19. The apparatus of claim 18, further comprising program code for indicating to said user an identity of an application that has requested access to said file when said user is prompted to confirm or reverse said decision to deny access.

20. The apparatus of claim 16, further comprising program code for creating a first interface through which said user can update said first database.

21. The apparatus of claim 16, further comprising program code for creating a second interface through which said user can update said second database.

22. The apparatus of claim 16, further comprising program code for encrypting said first database.

23. The apparatus of claim 16, further comprising program code for encrypting said second database.

24. The apparatus of claim 16, further comprising program code for creating a distributed database comprising a file within each directory containing one or more of said files which were identified by said first database to be included in said safe zone, wherein said first database comprises said distributed database, and wherein said filter accessing said first database comprises said filter accessing the files of said distributed database to verify whether said file for which access has been requested is within said safe zone.

25. The apparatus of claim 24, further comprising program code for encrypting the files of said distributed database.

26. The apparatus of claim 16, further comprising program code for attempting to determine whether said request for access was initiated by a Trojan process if said request for access is determined to have been made to a file within said zone, and if said request for access is determined to be authorized.

27. The apparatus of claim 26, wherein the program code for attempting to determine whether said request was initiated by a Trojan process further comprises program code for determining what application said request appears to be associated with and for determining whether a timestamp which is associated with said request is consistent with one or more timestamps associated with the application's install.

28. The apparatus of claim 26, wherein the program code for attempting to determine whether said request was initiated by a Trojan process further comprises program code for determining whether a directory from which said request was launched is an appropriate location for the process making said request to be stored.

29. The apparatus of claim 16, wherein said filter is a part of an operating system which is installed on said computer.

30. The apparatus of claim 16, wherein said filter is only activated by remote queries to said computer.

31. An apparatus which enables a user to prevent unauthorized access to files stored on a computer, comprising:
means for identifying files stored on the computer to be included in a safe zone;
means for defining authorized accesses to said files within said safe zone;
means for determining whether a file for which access has been requested is within said safe zone; and
means for determining whether said request to access said file has been authorized.
